(19) United States
(12) Patent Application Publication
(10) Pub. No.: US 2016/0133149 A1
(43) Pub. Date: May 12, 2016

(54) BLENDED BRAIN-TRAINING AND CURRICULAR-CONTENT LEARNING METHODS AND APPARATUS

(71) Applicant: Yale University, New Haven, CT (US)

(72) Inventor: Bruce E. Wexler, Hamden, CT (US)

(21) Appl. No.: 14/935,266

(22) Filed: Nov. 6, 2015

Related U.S. Application Data
(60) Provisional application No. 62/078,830, filed on Nov. 12, 2014.

(51) Int. Cl. G09B 7/06; G09B 5/02; G09B 17/00; G09B 19/06; G09B 19/00; G09B 19/02

(52) U.S. Cl. CPC G09B 7/06; G09B 19/0046; G09B 19/025; G09B 17/003; G09B 19/00; G09B 19/06; G09B 5/02

(57) ABSTRACT

Methods and apparatus for facilitating curricular content learning. The method comprises determining an initial order to present different types of learning modules to a user during a learning session. The learning modules include a curricular content learning module and a brain-training module configured to activate at least one brain system used for performing the curricular content learning module. The method further comprises presenting a first learning module of the plurality of learning modules on a user interface of a computer based, at least in part, on the initial order, recording user inputs during performance of the first learning module by a user, and updating the initial order based, at least in part, on the recorded user inputs to produce an updated order. A second learning module of the plurality of learning modules is presented on the user interface of the computer based, at least in part, on the updated order.

### RELATED APPLICATIONS

The present application claims priority under 35 U.S.C. §119(e) to U.S. Provisional Patent Application Ser. No. 62/078,830, filed Nov. 12, 2014 and entitled “Blended Brain-Training and Curricular-Content Learning Methods and Apparatus,” which is herein incorporated by reference in its entirety.

### BACKGROUND

To ensure that students receive a well-rounded education, school curriculums often include lessons focused on establishing competency in core subjects such as reading, writing, and mathematics. Some children struggle with learning curriculum content in school for a variety of reasons. For example, some children have difficulty attending to and sustaining effort during curriculum learning. Additionally, limitations in the appeal or “fun” of curricular materials themselves may be another factor that leads to poor learning of curriculum content for some children.

### SUMMARY

Children differ from one another in their areas of cognitive strength and weakness. Individual areas of weakness can significantly compromise learning of curricular content. Some embodiments are directed to a blended brain training and curricular content teaching program that addresses this important problem in a novel way by combining the effects of brain-training with curricular content learning. Each child's areas of greatest weakness are determined through built in tests and analysis of responses on the training tasks. Based, at least in part, on these assessments, specific kinds of cognitive skills exercises are given to each child prior to performing a curricular content module in order to prime, activate and improve the weak cognitive skill and improve learning of the curricular content. Curricular content modules are selected for that child that teach the material in a way that draws on their individual areas of cognitive strength. In contrast to conventional classroom-based curricular content learning techniques which focus on what is best for most students in the class, some embodiments enable classroom teachers to customize learning for each child to facilitate the learning of curricular content by individual children in the teacher's class.

As discussed in more detail below, in some embodiments, the impact of performing different cognitive skills training modules just before performing a curricular content module is evaluated, and the cognitive skills training modules to compare are chosen based, at least in part, on ongoing assessment of the child's areas of relative cognitive strength and weakness, and based upon comparing the effects of different types of cognitive training on immediately subsequent curricular content learning.

Computer-presented brain training programs have recently been developed to improve thinking abilities essential for learning; a brain-based content-independent pedagogy. Separately, computer-based curricular content games to present information such as math facts and reading have been developed. Some embodiments described herein are directed to bringing these two fundamentally different aspects of education technology together for the first time in ways that make each more powerful and effective and make possible previously inconceivable customization or individualization of instruction.

Some embodiments are directed to computerized techniques for presenting cognitive skills training and curricular content learning in close succession to enable the cognitive skills training to prime or activate portions of the brain that facilitate the learning of the curricular content. For example, placing cognitive skills training immediately before a curricular content learning module may activate brain processing systems necessary for learning the curricular content and thereby improve learning of the curricular content.

Some embodiments are directed to automatically controlling, individualizing, and/or evaluating multiple aspects of the interactions between cognitive skills training and curricular content learning.

Some embodiments are directed to computerized techniques for presenting different types of cognitive skill exercises and their associated brain activation to facilitate different kinds of curricular content learning. By analyzing how children are learning the curricular content, the relationships between cognitive skills training and curricular content learning can be studied and the presentation of the cognitive skill exercises may be adjusted based on this analysis, as discussed in further detail below. For example, determining which one or more cognitive skill exercises are most effective for facilitating specific types of curricular content learning for an individual may enable the creation of progressively more effective sequences of cognitive skills-brain activation exercises followed by specific types of curricular content learning for that individual.

Different individuals learn in different ways, and have different profiles of cognitive skill strengths and weaknesses. Some embodiments enable the identification of and the ability to address cognitive skill weaknesses impacting curricular content learning on an individual student basis.

Based on the above information gained on each individual, some embodiments enable the identification of and provide the type of cognitive skills training to each individual that is most useful to increase that individual's acquisition of curricular content.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of an illustrative process for combining brain-training exercises with curricular content learning in accordance with some embodiments;

FIG. 2 is a portion of a user interface for selecting a next learning module to complete in accordance with some embodiments;

FIG. 3 is a portion of a user interface for a mathematics learning module that may be used in accordance with some embodiments;

FIG. 4 is a portion of a user interface for a reading learning module that may be used in accordance with some embodiments; and

FIG. 5 is a schematic diagram of an illustrative computer system on which some embodiments may be implemented.

### DETAILED DESCRIPTION

Many children have trouble learning in school because of limitations in cognitive abilities important in learning. These core cognitive capacities include, but are not limited to, sustained attention, response inhibition, working memory, cognitive flexibility and speed of information processing. The inventors have recognized and appreciated that computer-implemented brain-training programs designed in accordance with some embodiments may improve these core cognitive capacities. Preliminary data suggests that children who have used the techniques described herein show greater gains in school-administered standardized tests of curricular content, suggesting that the brain training translated into better learning during other parts of the school day. Accordingly, this evidence supports the proposition that brain training can improve cognitive abilities and improve learning of curricular content.

Some embodiments are directed to addressing deficiencies in the conventional curricular content learning process by substantially increasing the positive transfer of cognitive skill training to increase curricular content learning and individualizing the cognitive skills training to maximize the transfer to curricular content learning in people with different cognitive skills and learning profiles.

As described in further detail below, some embodiments include attention and executive function training comprising multiple game or exercise modules that the child selects among each day within constraints based on their training records and needs. Additionally, grade-specific curricular content learning modules are added to that daily “menu,” with the curricular content also presented as learning modules/games. The curricular content learning modules may be, for example, math facts and science experiments, or chapters in a historical novel game. Presenting brain-training exercises together with curricular content learning modules in a single learning session achieves synergy between the training of the critical thinking skills (e.g., attention and executive function) and their immediate application to content learning in novel ways not possible with conventional content learning techniques. Doing the attention training, for example, just before a curricular content module increases engagement in the curricular content. Doing the curricular content module just after the attention training “applies” the attention training and helps consolidate and generalize its effects.

In some embodiments, recording every key stroke during completion of the modules creates opportunities for large sample data analytics designed to improve all the modules, and to elucidate the relationships between the modules that train thinking abilities and those that deliver curricular content, both within a single session and across several months of use. Such data analytics and dynamic updating of learning module selection and presentation are not possible with conventional curricular content learning techniques.

In some embodiments, an example of which is described in more detail below, the brain training exercises include six modules that together constitute a multidimensional executive function training program that begins with simple sustained attention, then progressively adds response inhibition, cognitive flexibility, working memory and multiple simultaneous attention, category formation and pattern recognition, as well as training faster information processing.

As discussed in more detail below, a computer-based system programmed to implement some embodiments comprises a curricular content module and a scheduling module. The curricular content module may be configured to provide one or more math, reading, or other curricular content type learning modules for a particular grade level. The scheduling module may be configured to allow the user to select a brain training or curricular content module they would like to complete. After a student has completed that module, they choose another module to complete, until the full training session is complete. At each choice point, only a subset of the full array of modules may be offered for selection. As discussed further below, some embodiments include rules governing the selection of modules presented at each choice point. These rules assure adequate balance among the modules played and, importantly, govern the temporal relationship between the brain training and curricular content modules.

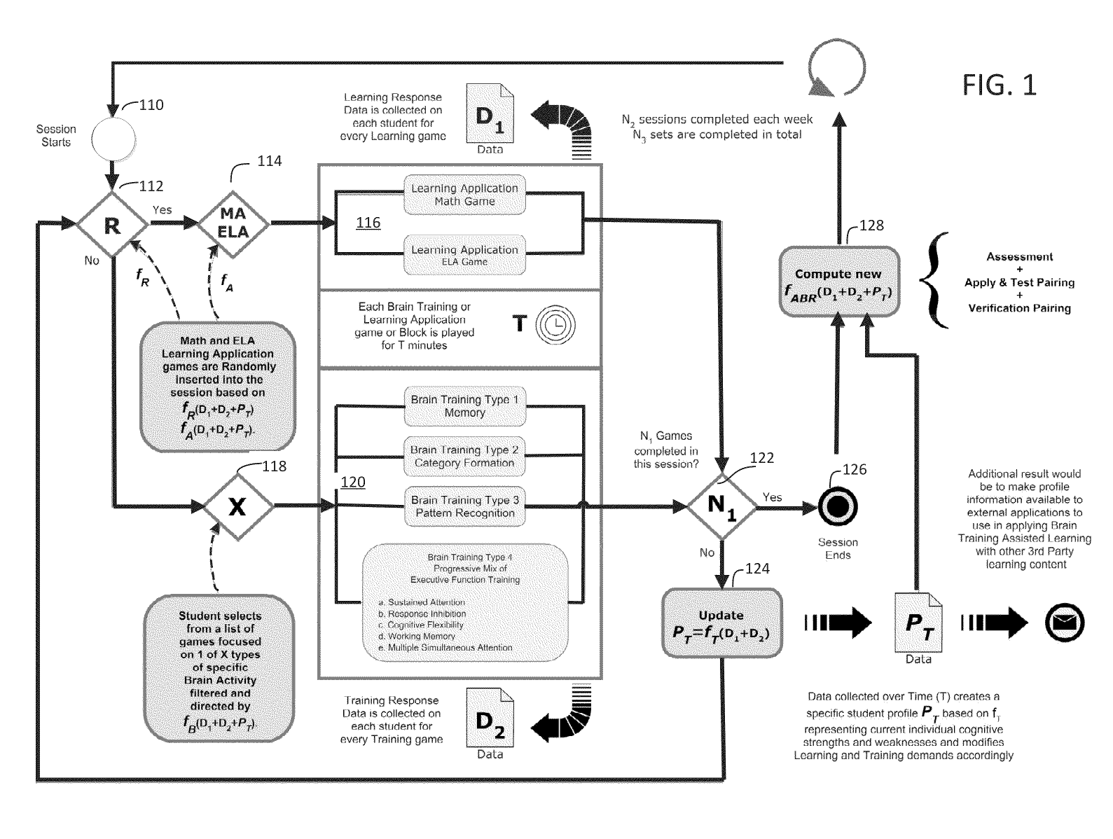

FIG. 1 is a flowchart of an illustrative process for combining brain-training with curricular content learning in accordance with some embodiments. In act 110, a student starts a new learning session. In some embodiments, each learning session may include N₁ modules, wherein the N₁ modules include one or more brain-training exercises and one or more curricular content learning exercises. In one implementation N₁=6, where four of the modules are brain-training exercises and two of the modules are curriculum content learning exercises. Non-limiting examples of curricular content learning exercises are described in more detail below.

The process of FIG. 1 then proceeds to act 112, where it is determined whether the next module in the learning session is a brain-training exercise or a curricular content learning exercise. The determination may be made in any suitable way. In some embodiments, curricular content learning exercises are randomly inserted into the learning session based one or more factors including, but not limited to, the student's learning response data, training response data, and student profile information. For example, as shown in FIG. 1, the determination of whether the next module should be a brain training exercise or a curricular content learning exercise may be based, at least in part, on a function f_{R}(D₁+D₂+P_{T}), where D₁ corresponds to learning response data collected on each student for each curricular content learning module completed by the student, D₂ corresponds to training response data collected on each student for each brain training exercise completed by the student, and P_{T} corresponds to a specific student profile based on data collected over time. The information from each of these factors may be combined and/or weighted in any suitable way, and embodiments are not limited in this respect.

If it is determined in act 112 that a curricular content learning module is to be completed next, the process proceeds to act 114, where it is determined which type of curricular content learning module to present. Two types of curricular content learning modules—mathematics (MA) and language arts (ELA)—are shown in FIG. 1. However, it should be appreciated that any suitable number and/or type of curricular content learning module may alternatively be used. For example, in some embodiments a curricular content learning module for learning history, social studies, foreign language, or any other academic content material may be used. In some embodiments, only a single type of curricular content learning module (e.g., mathematics) may be used. In such embodiments, the decision of which type of curricular content learning module to use in act 114 may not be necessary, as the same type of curricular content learning module would be used every time. For systems that include at least two choices of curricular content learning modules, the determination of which curricular content learning module to use may be made in any suitable way. As shown, the determination may be made based, at least in part, on a function f_{A}(D₁+D₂+P_{T}), which considers the same factors as the function f_{R} discussed above. It should be appreciated however, that embodiments do not require the same factors to be used, and in embodiments where the same factors are used, different weighting factors or subsets of information may be used to make the determination in act 114 compared to the determination in act 112.

After a particular type of curricular content learning module has been selected in act 114, the process proceeds to act 116, where the selected type of curricular content learning module is presented to the student for learning. Each curricular content learning module may be presented to the student for any suitable number of minutes (T). During and/or after the completion of the curricular content learning module, learning response data (D₁) may be collected and stored.

Returning to act 112, if it is determined that a curricular content learning module should not be the next module during the learning session, the process proceeds to act 118, where it is determined which type of brain-training module should be the next module in the learning session. In some embodiments, a student may be presented with a set of brain-training exercises, and the user may be instructed to select from among the exercises in the set. The brain-training exercises available for selection by the student may be determined based on a function f_{B}(D₁+D₂+P_{T}), which considers the same factors as the functions f_{R} and f_{A} discussed above. As with the function f_{A} discussed above, not all embodiments require the use of these same factors for function f_{B}, and in embodiments where the same factors are used, the factors may be used differently in the function f_{B} to select an appropriate set of brain-training exercises to present to the user.

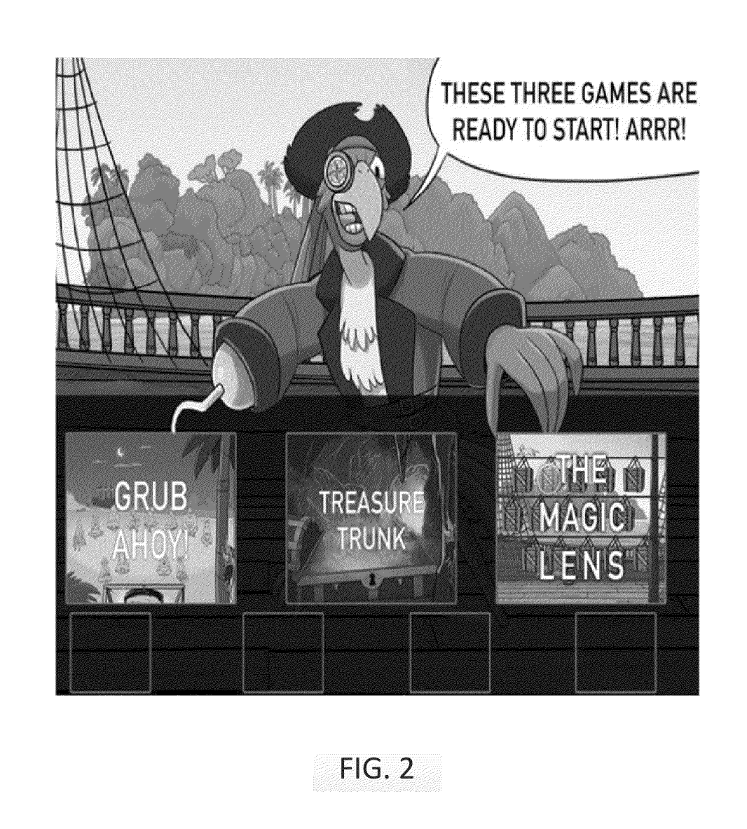

FIG. 2 illustrates a portion of a user interface that may be used to present a selection of brain-training exercises to a student. As shown, three different brain-training exercises are shown for selection. However, it should be appreciated that any suitable number of brain-training exercises may alternatively be shown for selection. As described above, in some embodiments, the brain-training exercises displayed for selection by a user may be based, at least in part, on a student's learning profile and/or performance during prior brain-training exercises or curricular content learning modules.

Once a particular brain-training exercise has been selected in act 118 (either by a student or automatically by one or more processors), the process proceeds to act 120, where the brain-training exercise is performed by the student. FIG. 1 illustrates several types of brain-training exercises that may be performed in accordance with some embodiments. However, it should be appreciated that any other suitable brain-training exercises may additionally or alternatively be used. In some embodiments, one or more of the brain-training exercises presented to the user are selected, at least in part, to prime and/or activate regions of the brain thought to facilitate curricular content learning in a subsequently presented curricular content learning module during the learning session. During and/or after the completion of the brain-training module, training response data (D₂) may be collected and stored.

After the student has completed either a curricular content learning module or a brain-training exercise module, the process proceeds to act 112, where it is determined whether N₁ modules have been completed in the learning session. For example, in implementations where each learning session includes six modules, it is determined in act 112 whether the total number of modules presented to the student is equal to six. If it is determined in act 112 that more modules remain in the learning session (e.g., less than N₁ modules have been performed), the process proceeds to act 124, where the student profile P_{T} is updated based, at least in part, on the learning response data D₁ and/or the training response data D₂. The process then returns to act 112, where the type of the next module in the learning session is determined, as discussed above.

As should be appreciated from the foregoing, in the illustrated embodiment of FIG. 1, the functions f_{A}, f_{B}, and f_{R} collectively work together to determine the order of modules in a learning session. In some embodiments, the selection order of modules to be performed during a learning session may be fixed prior to the start of the learning session. In other embodiments, the selection order of the modules may be updated dynamically “on-the-fly” to take into consideration the latest performance data of the student. Such dynamic updating of information (e.g., the student's profile P_{T}) provides benefits of constant feedback resulting in optimal learning conditions for each student not possible using conventional techniques for curricular content learning.

As shown, the student's profile information P_{T} is updated after each module is performed during a learning session. In some embodiments, student profile information P_{T} may be updated at less frequent intervals, if desired. For example, in some embodiments student profile information P_{T} may be updated after a learning session is completed or at any other suitable interval.

If it is determined in act 122 that N₁ modules have been completed in the learning session, the process proceeds to act 126, where the learning session ends. The process then proceeds to act 128, where the functions f_{A}, f_{B}, and f_{R} are updated based, at least in part, on the information collected during the learning session. The process then returns to act 110 to start a new learning session, when desired. In some embodiments, N₂ learning sessions are completed by the student each week, with N₃ total sessions being competed in total.

As discussed briefly above, in one implementation the number N₁ of modules completed in each learning session may be six modules, with four of the modules being brain-training modules and two of the modules being curricular content learning modules. For example, during a learning session, each student may complete six modules, each being five minutes long for a total learning session time of 30 minutes. In this implementation students may complete N₂=3 or 4 learning sessions each week for a total of N₃=60 or more learning sessions. It should be appreciated that the values of N₁, N₂, and N₃ above are provided merely for illustration and are not limiting.

In some embodiments, learning during the curricular content blocks during each learning session are compared to determine the effect of brain activity priming/activation stimulated during the brain-training module(s) preceding each curricular content block on learning during that block.

As discussed above, in some embodiments, users (e.g., students) may be given a choice regarding which of the brain-training exercises to complete during a training session, but the choices presented to the student may be constrained based, at least in part, on the history of each student's choice to ensure proper balance among the brain-training exercises and to create data sets appropriate to systematically and efficiently evaluate the effects of brain activity priming using brain-training exercises on curricular content learning.

In some embodiments, the curricular content learning modules are presented as ‘surprises” with flashing on the screen “It's now time for a math (or reading or other curricular content type) game!”

The curricular content learning modules may be preceded by nothing (i.e., be the first module of the learning session) or the curricular content learning modules may be preceded by any of the other curricular content learning modules. As discussed above, in some embodiments, the order of modules during a learning session may be selected to promote brain-activation in brain regions used to learn curricular content presented during subsequent curricular content learning modules during the session.

In an exemplary implementation six different brain-training modules representing four types of brain-training: 1) memory, 2) category formation, 3) pattern recognition, and 4) a progressive mix of executive functions always including sustained attention, and adding progressively response inhibition, cognitive flexibility, working memory and multiple simultaneous attention are used, as shown in FIG. 1. In this implementation, the “surprise” curricular content learning modules are presented to provide the mix of pre-content game/content game types to analyze the effects of the pre-content module brain activity on content learning performance.

As discussed above in connection with FIG. 1, some embodiments include a scheduling module that determines the order of different types of modules for a student to complete both during a learning session and across learning sessions. The dynamic nature of the scheduling module enables such embodiments to probe learning patterns of individual students to provide additional brain priming and/or curricular content learning that is individualized to particular students thereby providing individualized instruction typically unavailable with conventional curricular content learning systems adopted in classrooms.

In some embodiments, the scheduling module cycles through multiple stages including an assessment stage, an apply and test stage, and a replacement stage. During the assessment stage, it is determined which brain-training module produces the best curricular content learning outcomes for each individual student. During the apply and test stage, a brain-training module identified in the assessment stage is selected to precede a particular curricular content learning module during a next training session. Also during the apply and test stage, a curricular content learning module in a next training session is preceded by another brain-training module or nothing to recheck the results of the initial assessment during the assessment stage. For example, as curricular content learning demands change as the curriculum progresses and as the student's own profile of cognitive strengths and weaknesses changes as a result of the cumulative effects of the brain training and growth over time, the scheduling module adapts to provide a combination of brain-training modules and curricular content learning modules that facilitates learning of curricular content for individual students. During the replacement stage, a primary pairing of pre-content brain-training exercise/curricular content learning module is adapted as appropriate based on the ongoing information determined from the apply and test stage.

### Illustrative Curricular Content Learning Modules

As discussed above, any suitable curricular content learning modules may be used in accordance with some embodiments to provide computer-based curricular content learning. The curricular content learning modules discussed below relate to curricular content for mathematics and elementary language arts, although it should be appreciated that any other suitable curricular content learning modules including, but not limited to, curricular content learning for science may be used.

An Illustrative Mathematics Module

In some embodiments, one or more curricular content learning modules for mathematics may be based, at least in part, on neuroscience research related to numerical cognition. In some embodiments, one or more mathematics modules may be based, at least in part, on the Common Core grade 2 (or any other suitable grade) math curriculum. For example, the modules may be based, at least in part, on an identification of critical teaching elements in mathematics as well as appropriate scaffolding techniques. An implementation of a mathematics module, described in more detail below focuses on extending understanding of base-ten notation and building fluency with addition and subtraction.

Many conventional computer-implemented games for teaching mathematics skills are the equivalent of digital reviews and quiz sheets. Some embodiments described herein are focused on creating curricular content learning modules that are significantly more sophisticated, as should be appreciated from the foregoing discussion.

In developing the mathematics content learning module described in more detail below, the goal was to teach students the concept of place value, specifically, the 10s and 100s place value so that when students regroup numbers in addition and subtraction they have a deep conceptual understanding of the numbers rather than completing the problems by rote or being unable to complete the problems at all.

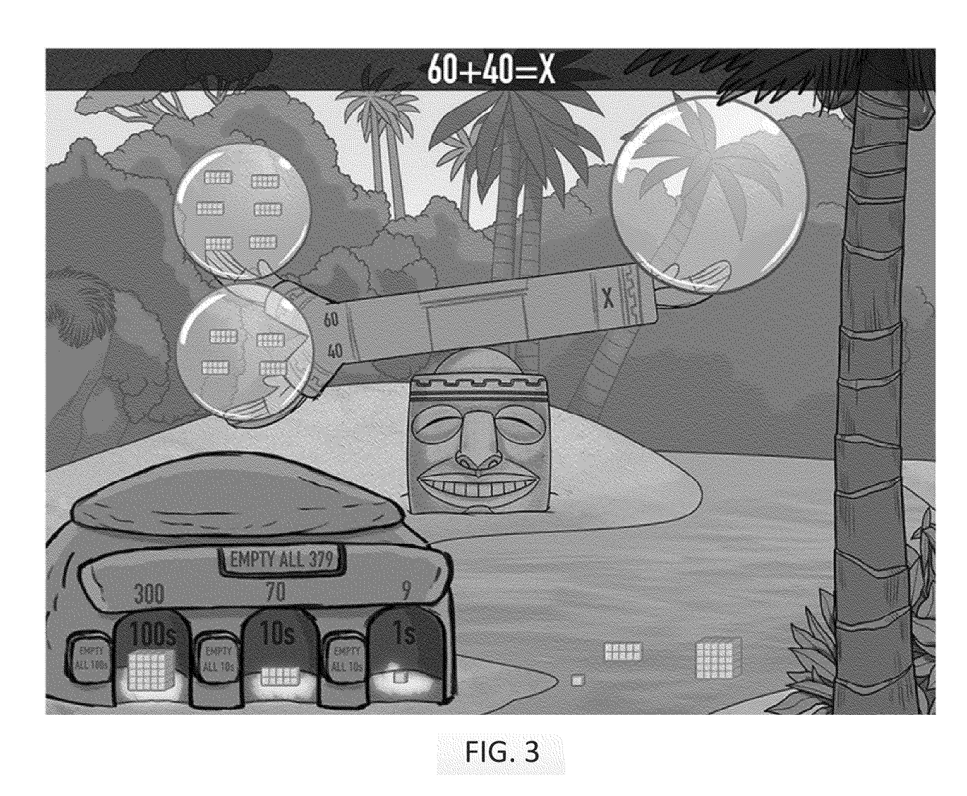

FIG. 3 illustrates an illustrative mathematics learning module called “The Secret Scale.” In this learning module Captain Bluefeathers tells the players that there is an ancient scale hidden in the jungle. The scale measures gold and allows those who help balance it to keep the gold they used. The game is based around the idea of Number Bonds—sets of three circles connected by lines, with a large circle containing a “whole” and the smaller circles containing its “parts.” In the game this visual structure is reimagined as a large stone totem forked in a T shape at the top. This shape changes depending on whether a level is focused on addition, or subtraction. For levels focused on addition, the T will have two smaller spheres on one side of the T, and a larger sphere on the other side. For levels focused on subtraction, the T will have only two total spheres, each the same size as the other, and each on either side of the top of the T.

Each puzzle in the game will focus the player to either add or subtract gold from a specific sphere, which will in turn be different from puzzle to puzzle. The player will be able to pull gold from a stream running through the game screen to solve the problems.

To teach students the concept of regrouping, students will be presented with a small goldsmith's furnace, which will have several features. The furnace consists of three squares each labeled as a space for l's 10's and 100's. To break gold when the correct denominations are not available in the stream, the player will be able to take a 10 or 100 from the stream and break it apart in the furnace by dropping it into one of the boxes in the furnace and breaking it with a hammer. A 100 will be broken in to ten 10s and a ten in to ten 1s. The resulting volumes of gold will be pushed back into the stream.

Additionally, this furnace will also function as a ‘regrouping machine’ as it will visually display regrouping. If the player adds more than nine 1's to the 1 square, when the tenth coin is added it will automatically combine the ten is into a 10, thus populating the 10 square with one 10 and leaving the 1 square empty. The same system will also hold true for creating 100's. As the game progresses, numbers displayed in Arabic numerals will be added to the scale and furnace.

Students will be instructed to complete each puzzle in as few moves as possible with the goal that students do not use the furnace to regroup unless they have to.

It is expected that the concepts of the scale and the furnace will reinforce number sense and an understanding of place value and will provide much needed practice within that carefully crafted game environment.

An Illustrative Reading Module

In some embodiments, one or more curricular content learning modules for reading modules may be based, at least in part, on the Common Core grade 2 (or any other suitable grade) reading curriculum. For example, the modules may be based, at least in part, on an identification of critical teaching elements in reading as well as appropriate scaffolding techniques. An implementation of a reading module focuses on phonics, which has been found to be an important component of successful reading.

The goal of the illustrative reading module is for students to practice reading decodable text of appropriate complexity for grades 2-3 that incorporates the specific code knowledge taught:
Long and short vowels in one-syllable words: ‘a’>/a/; ‘e’>/e/; >/i/; ‘o’>/o/; ‘u’>/u/;
Two-syllable words with any combination of the following syllable types: closed syllables, magic -e syllables, vowel digraph syllables, r-controlled syllables, open syllables, consonant -LE syllables;
Words with the following inflectional endings and suffixes: -ing, -ed;
Letter-sound correspondences: ‘a’ as /a/ (hat), /ae/ (paper), /a/ (about), or /aw/ (wall); ‘i’ as /i/ (hit), /ie/ (item), or /ee/ (ski); ‘o’ as /o/ (hop), /oe/ (open), or /u/ (son); ‘e’ as /e/ (pet), /ee/ (me), or / [symbol] / (debate); ‘u’ as /ue/ (unit) or /u/ (but); ‘y’ as /y/ (yes), /ie/ (try), /i/ (myth), or /ee/ (funny); ‘ir’ (bird), ‘ur’ (hurt), or ‘er’ as /er/ (her); ‘ar’>/ar/ (car) or /or/ (war); ‘al’>/ [symbol] /+/l/ (animal); >‘il’</ [symbol] /+/l/ (pencil); ‘ul’>/ [symbol] /+/l/ (awful); ‘el’>/ [symbol] /+/l/ (travel), ‘le’>/ [symbol] /+/l/ (apple); ‘tion’>/sh/+/ [symbol] /+/n/; ‘ph’>/f/ (phone); ‘ch’>/k/ (school); ‘wa’>/o/ (water);
Tricky words: he, she, we, be, me, the, was, of, a, do, down, how, to, two, what, where, why, from, once, one, could, would, should, there, said, says, why, word;
Words in which ‘c’>/k/ as in cat or /s/ as in city; ‘g’>/g/ as in got or /j/ as in gem;

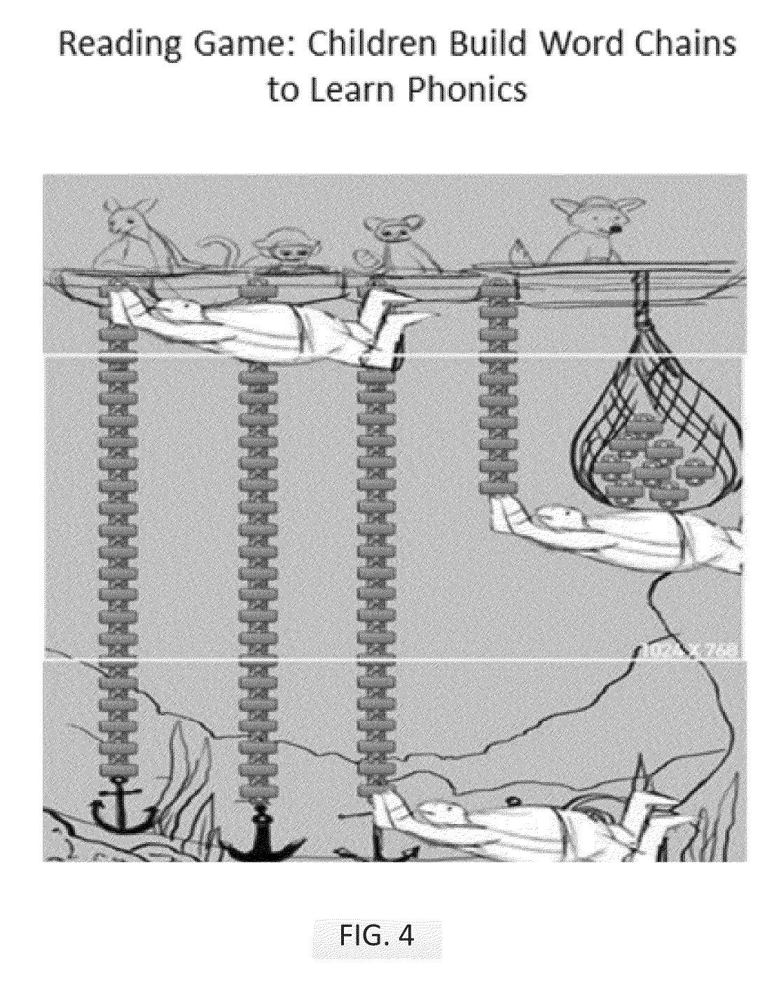

FIG. 4 illustrates a portion of a user interface for a reading game that may be used in accordance with some embodiments. In this game, Captain Bluefeather has begun collecting boats, as any good pirate should, but as they each arrive at his harbor he finds himself needing to chain them up to keep them from floating away. Luckily the captain has a whole lot of chain links with words in them that can be assembled into word chains that can keep the boats moored in the right spots.

As the curriculum states: students have been completing chaining exercises in CKLA since the earliest Kindergarten Units. This critical activity reinforces students' abilities to manipulate the sounds in words in which only a single phoneme/grapheme is changed (added or deleted) at a time, like cat>hat; cat>cab; at >hat; or cat>at.

In this game, the player is presented with a chain link labeled with a word, for example, Cat, and a set number of options such as car-mop-leg-map-tap-bat-hat.

Perhaps there is only one possible correct answer, or maybe there are two as in this instance bat or hat. Either way, the player selects a correct response, the new word is added, and a new list of possible chain links is presented to the student.

In this illustrative reading learning module, each level may have a table consisting of words in the first column and the words that are chainable from them listed in the row. This will code the parameters of what is an acceptable link in each chain as follows:

| | | | | | |
|---|---|---|---|---|---|
| Cat | Hat | Mat | Rat | Car | Cut |
| Cut | Mutt | Putt | Hut | Cat | Cot |
| Car | Bar | Star | Cat | Tar | Cur |
| Hat | Cat | Mat | Rat | Ham | Hut |

The level can specify at the start exactly how many links are needed to complete it, or an approximate distance can be shown. Either way, the student has completed the level when the boat has been linked all the way to the nearest mooring point. For example, a possible chain could by the end be:

cat-bat-hat-mat-pat-pass-mass-sass-same-name-game-

The ending and even middle words can become radically different and unrelated to the starting word and as such, the player has the chance to make something new and original, as well as a little bit silly, in each and every game.

Difficulty and complexity can be scaled up to match movement in the curriculum by increasing the number of chain links to complete a level as well as by adding incrementally more complex words.

Given that this game provides a dynamic environment for students where they can creatively construct a chain and build something, where every choice is a product of a previous choice, students will be more engaged and learn more quickly than in the traditional games where students practice reading by rote. This game is different from many conventional reading solutions as it is not just reflexive or reactive but rather self-directed and it builds on players' choices.

The techniques described herein for providing individualized brain training exercises to prime and/or activate one or more brain systems used in curricular content learning to facilitate learning of the curricular content may also be used to facilitate learning in contexts other than academic content learning. For example, in some embodiments, brain training module(s) may be used to prime/activate one or more brain systems to facilitate various types of adult professional learning (e.g., military training, etc.) or to enhance performance on certain jobs, such as air traffic control, doctors performing medical procedures, preparation for business meetings, etc. Providing targeted brain training immediately before engaging in such activities may improve performance during the activities.

In some embodiments, the techniques described herein may be used to monitor performance during an activity and to provide brain training at suitable times to stimulate brain system(s) to improve performance, as needed. For example, the performance of air traffic controllers may be periodically monitored during their shift using one or more brain training exercises to assess core skills (e.g., attention) needed to perform the job properly, and individuals with deficient core skills may be identified. Targeted brain training to improve performance on the deficient core skills may be provided, as determined by the monitoring to improve the individual's job performance.

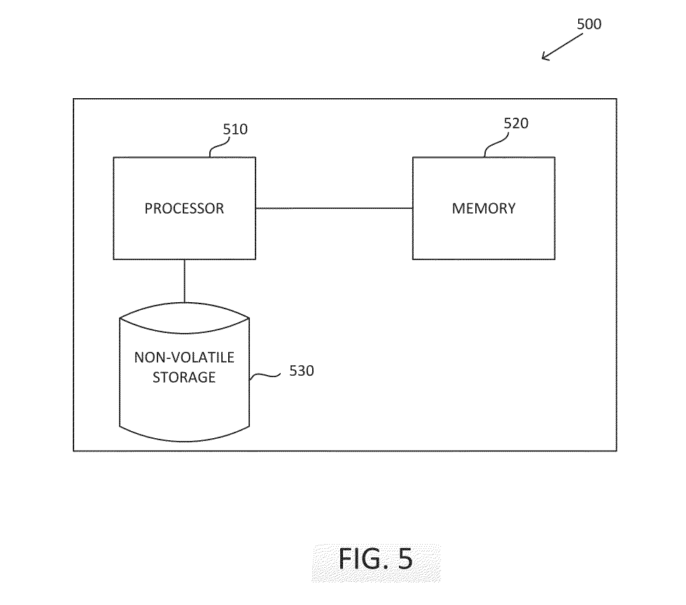

An illustrative implementation of a computer system 500 that may be used in connection with any of the embodiments of the invention described herein is shown in FIG. 5. The computer system 850 may include one or more processors 510 and one or more computer-readable non-transitory storage media (e.g., memory 520 and one or more non-volatile storage media 530). The processor 510 may control writing data to and reading data from the memory 520 and the non-volatile storage device 530 in any suitable manner, as the aspects of the present invention described herein are not limited in this respect. To perform any of the functionality described herein, the processor 510 may execute one or more instructions stored in one or more computer-readable storage media (e.g., the memory 520), which may serve as non-transitory computer-readable storage media storing instructions for execution by the processor 510.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with hardware (e.g., one or more processors) specially-programmed using computer-executable functions to perform the functions recited above.

In this respect, it should be appreciated that one implementation of the embodiments of the present invention comprises at least one non-transitory computer-readable storage medium (e.g., a computer memory, a USB drive, a flash memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A method of facilitating curricular content learning, the method comprising:
determining, by a computer processor, an initial order to present different types of learning modules to a user during a learning session, wherein the learning modules include a curricular content learning module and a brain-training module configured to activate at least one brain system used for performing the curricular content learning module;
presenting a first learning module of the plurality of learning modules on a user interface of a computer based, at least in part, on the initial order;
recording user inputs during performance of the first learning module by a user;
updating the initial order based, at least in part, on the recorded user inputs to produce an updated order; and
presenting a second learning module of the plurality of learning modules on the user interface of the computer based, at least in part, on the updated order.

2. The method of claim 1, wherein the first learning module is the brain-training module configured to activate at least one brain system used for performing the curricular content learning module and the second learning module is the curricular content learning module.

3. The method of claim 1, wherein determining an initial order comprises scheduling the brain-training module for presentation during the learning session immediately before presentation of the curricular content learning module such that performance of the brain-training module primes the at least one brain system used for performing the curricular content learning module.

4. The method of claim 1, wherein the learning modules include a first brain-training module configured to activate a first brain system and a second brain-training module configured to active a second brain system, and wherein the first learning module is the first brain training module and the second learning module is the second brain-training module.

5. The method of claim 1, further comprising:
storing, on a storage device associated with the computer processor, profile information for a user, wherein the profile information is determined based on the user's performance in performing a plurality of learning modules, and
wherein determining an initial order comprises determining an initial order based, at least in part, on the stored profile information for the user.

6. The method of claim 5, further comprising:
updating the profile information for the user based, at least in part, on the recorded user inputs during performance of the first learning module and/or the second learning module.

7. The method of claim 6, wherein updating the initial order comprises updating the initial order based, at least in part, on the updated profile information for the user.

8. The method of claim 1, wherein the brain-training module is configured to activate at least one brain system involved in at least one of sustained attention, response inhibition, working memory, cognitive flexibility, and speed of information processing.

9. The method of claim 1, wherein the first learning module is the brain-training module, and wherein updating the initial order comprises determining that a next learning module in the learning session should be the curricular content learning module.

10. The method of claim 1, wherein the first learning module is the brain-training module, and wherein updating the initial order comprises determining that a next learning module in the learning session should be another brain-training module.

11. The method of claim 10, wherein the another brain-training module is configured to activate a different brain system than the brain-training module presented as the first learning module.

12. The method of claim 1, wherein the curricular content learning module is configured to teach mathematics, reading, science, history, social studies, or a foreign language.

13. The method of claim 1, wherein the updated order and the initial order include the same order of presentation of the learning modules during the learning session.

14. A computer system, comprising:
a storage device configured to store computer-executable instructions for presenting each of a plurality of learning modules on a user interface of the computer system, wherein the learning modules include a curricular content learning module and a brain-training module configured to activate at least one brain system used for performing the curricular content learning module; and
a computer processor programmed to:
determine an initial order to present a predetermined number of learning modules to a user during a learning session;
present a first learning module of the plurality of learning modules on the user interface based, at least in part, on the initial order;
record user inputs during performance of the first learning module by a user;
update the initial order based, at least in part, on the recorded user inputs to produce an updated order; and
present a second learning module of the plurality of learning modules on the user interface of the computer based, at least in part, on the updated order.

15. The computer system of claim 14, wherein determining an initial order comprises scheduling the brain-training module for presentation during the learning session immediately before presentation of the curricular content learning module such that performance of the brain-training module primes the at least one brain system used for performing the curricular content learning module.

16. The computer system of claim 14, wherein the first learning module is the brain-training module, and wherein updating the initial order comprises determining that a next learning module in the learning session should be the curricular content learning module.

17. The computer system of claim 14, wherein the first learning module is the brain-training module, and wherein updating the initial order comprises determining that a next learning module in the learning session should be another brain-training module configured to activate a different brain system than the brain-training module presented as the first learning module.

18. The computer system of claim 14, wherein the at least one storage device is further configured to store profile information for the user, wherein the profile information is determined based on the user's performance in performing a plurality of learning modules, and
wherein determining an initial order comprises determining an initial order based, at least in part, on the stored profile information for the user.

19. A non-transitory computer readable storage medium encoded with a plurality of instructions, that when executed by a computer processor perform a method, comprising:
determining an initial order to present a predetermined number of learning modules to a user during a learning session, wherein the learning modules include a curricular content learning module and a brain-training module configured to activate at least one brain system used for performing the curricular content learning module;
presenting a first learning module of the plurality of learning modules on the user interface based, at least in part, on the initial order;
recording user inputs during performance of the first learning module by a user;
updating the initial order based, at least in part, on the recorded user inputs to produce an updated order; and
presenting a second learning module of the plurality of learning modules on the user interface of the computer based, at least in part, on the updated order.

20. The non-transitory computer readable storage medium of claim 19, wherein the method further comprises:
storing, on a storage device associated with the computer processor, profile information for a user, wherein the profile information is determined based on the user's performance in performing a plurality of learning modules, and
wherein determining an initial order comprises determining an initial order based, at least in part, on the stored profile information for the user.
